(19) United States
(12) Patent Application Publication
(10) Pub. No.: US 2005/0127096 A1
(43) Pub. Date: Jun. 16, 2005

(54) Apparatus for dispensing hazardous chemicals

(75) Inventors: Darryl W. Cole, Mexico, MO (US); Kent Barta, Fitchburg, WI (US)

Correspondence Address: MEDLEN & CARROLL, LLP, Suite 350, 101 Howard Street, San Francisco, CA, 94105, US

(73) Assignee: Pakers Chemical, Inc., Mexico, MO (US)

(21) Appl. No.: 10/914,694

(22) Filed: Aug. 9, 2004

Related U.S. Application Data
(60) Provisional application No. 60/493,665, filed on Aug. 8, 2003.

(51) Int. Cl. B67D 5/32; B67D 5/33; B67D 5/378; B67D 1/16

(52) U.S. Cl. 222/108

(57) ABSTRACT

An environmentally safe chemical dispensing system incorporates an enclosure containing structural elements including conveyance, containment, and control features which eliminate major sources of risk from spillage, and other sources of industrial chemical accident. The system is based upon an analysis of historical mishaps, and involves materials compatibility, functional utility, and practicability in a mechanical format involving a pump, and connection to a chemical source.

This Application claims priority to U.S. Provisional Patent Application Ser. No. 60/493,665, filed Aug. 8, 2003.

### BACKGROUND OF THE INVENTION

The transportation, storage, and use of hazardous chemicals presents a significant management challenge. Hazardous chemicals are designated HAZMAT by the U.S. Dept. of Transportation and are subject to strict regulation as to labeling and containment. For example, hydrogen peroxide in industrial concentrations of 35%, 50%, and 70% ship under UN2014 (oxidizer), caustic soda under UN1760 (corrosive), strong acids such as phosphoric under UN1805 (corrosive), and alcohol such as isopropyl under UN1219 (flammable). The safe use of these chemicals is of paramount importance, as a significant number of accidents occur as a result of misuse, spills, failed and improperly designed dispensing equipment.

Many of the advances in dispensing technology have taken place in the field of oil and gasoline. The rupture of underground gas storage tanks and inadvertent spills and leaks has led to incidents of substantial environmental pollution. Resultant clean up costs and regulatory fines have created a strong incentive for design of safety equipment that prevents or at least contains leaks. U.S. Pat. No. 5,527,130 discloses an underground piping system which contains leaks in an underground enclosure and communicates to a surface dispenser via double piping that maintains an interstitial space between pipes. U.S. Pat. No. 5,040,408 discloses a secondary containment system in which a primary line may be completely installed and integrity tested before the secondary piping is installed. Telescoped piping also permits bending without leaking at seams. The prior use of double walled vessels for containment of a primary containment breach is known (See U.S. Pat. No. 4,568,925). The situation where two incompatible chemicals are used together in a common application has also been addressed. U.S. Pat. No. 6,463,611 discloses the sequential pumping of separate chemicals through a common manifold, with an intervening rinse of the manifold between pump actions.

In many instances, business firms have shunned hazardous chemicals in favor of chemical alternatives deemed safer to handle and use. In the meat packing field, for example, in which peroxide bleach is required to whiten offal products, many plants discontinued use of liquid hydrogen peroxide and substituted sodium percarbonate. Principal concerns were burns, eye injuries, spills resulting in fires, burned clothing, and other hazards. Caustic soda or strong acid based liquid products also pose a concern, so that firms substitute products in solid form. While chemicals in solid form such as sodium percarbonate or caustic soda may have some perceived safety advantages, they actually involve more direct handling than liquid versions, and are approximately twice as expensive than the liquid chemicals from which they are derived. For example, sodium percarbonate is a chemical complex formed by spraying hydrogen peroxide onto a soda ash substrate and then drying. The product upon re-hydration simply liberates hydrogen peroxide into solution. Caustic soda beads are derived from a 50% sodium hydroxide stream from a chlor-alkali plant through a series of expensive processing steps. These additional costs are incurred because of safety concerns.

There exists a substantial need in many industries to provide a dispensing system for hazardous chemicals such as hydrogen peroxide and other oxidizers, strong acids and bases, and flammable products, that is safe, and can secure the delivery of these substances to the point of use, free of leaks, adverse contact with the environment, and persons having responsibility for their use.

### SUMMARY OF THE INVENTION

The present invention operates under a novel theory of hazard, namely, engineering a chemical dispensing device directly taking into account, in a quantitative aspect, the risk factors associated with design defects in conventional systems that lead to accidents and other mishaps, that have been substantiated historically. The basic premise of this theory is to safely convey a liquid hazardous chemical from a source to its point of intended use, utilizing a dispensing system having minimal risk of failure, default, or endangerment to the environment or individuals having responsibility for handling or using the chemical.

It is preferable that the dispensing system of the present invention be dedicated to each hazardous chemical being dispensed and that no system physically incorporate dispensing means for more than one chemical in the same enclosure, even if two or more chemicals are not chemically incompatible. Thus, the dispensing system herein may dispense chemicals from a chemical source to more than one point of use, but the identity of the chemical should be the same for each dispensing apparatus.

According to the present invention, an apparatus for safe dispensing of a hazardous chemical or chemicals provides an enclosure formed upon substantially six sides including an opening on one side and having closed top and bottom surfaces, and a back plate mounted therein preferably on the back side. There is an L-shaped base plate having a vertical mounting lip placed within the enclosure and secured by fastening means to form upper and lower cavities in the enclosure. The horizontal base plate is attached to the back plate only by the fastening means through the mounting lip, and is not sealed at the edges. The base plate horizontal surface may be dimensionally smaller than the enclosure to provide additional liquid communication between the upper and lower cavities.

One or a plurality of stackable pumps materially compatible to the enclosure are mounted on the base plate. This pump or pumps are disposed between a materially compatible chemical inlet tube and chemical outlet tube. The inlet and outlet tubes pass through the side or sides of the enclosure to each pump and are secured to the sides by bulk head fittings. The tubes are bent in a somewhat S-shaped pattern and rotated in an angularity to permit axial alignment of input and output tubes to each pump. The tubes are connected on the pump end by materially compatible compression type fittings.

At the bottom of the enclosure and directly beneath the base plate, chemical collecting means sealable to the vertical sides of the enclosure is provided to prevent liquid reflux to the upper cavity of the enclosure. The collecting means channels liquid through a connection to one or a plurality of drain means in the bottom surface of the enclosure. The apparatus may also be provided with flushing means comprising a tubular loop connecting a source of decontaminating fluid to the chemical inlet tube, and further having a drain connected to the chemical outlet tube, and a valve controlling ingress of decontaminating fluid.

The present invention further provides a method for dispensing liquids in which conveyance of the liquids is carried out through materially compatible components, have a flow generative of characteristic vibration from action of a pump or pumps, the energy of vibration being dispersed and dissipated by resonance of the system by materially compatible resonable components.

### BRIEF DESCRIPTION OF THE DRAWINGS

FIG. 1 is a plan view of the enclosure of the invention showing the configuration of pumps, activating mechanisms for operating the pumps in a preferred embodiment, a planar view of the angularity of tubes, and an injection manifold. It also depicts in relief an example of a chemical collecting means valley pan.

FIG. 2 is a plan view showing the configuration of the flushing means in its preferred embodiment.

FIG. 3 is a plan view of the back plate.

FIGS. 4a and b is a plan view of the base plate.

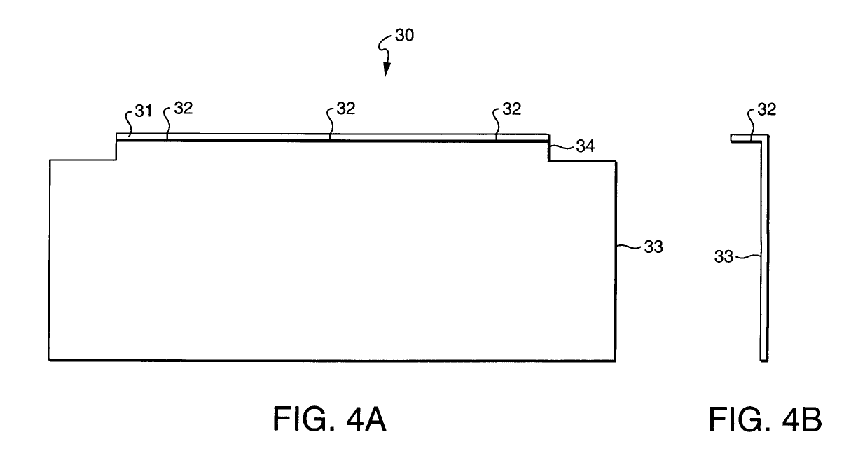

FIG. 5 is a top elevation view of the enclosure of the invention demonstrating the preferred angularity of tubes.

FIG. 6 is a perspective drawing of an example of a compression fitting.

FIG. 7 is a plan end view showing the double axial configuration of inlet and outlet tube connections.

### DESCRIPTION OF THE PREFERRED EMBODIMENT

In conventional dispensing of hazardous chemicals, an apparatus typically includes a pump mounted on a frame or in an enclosure connected to a source of chemical, usually a drum or tote via flexible plastic tubes. Couplings are generally plastic involving attachment of a plastic hose of one type of material joined to a nipple of a second type of plastic and secured by a hose clamp. Alternatively, hard plumbed PVC piping may be employed with standard PVC unions, T fittings, and elbows. The most common type of pump for dispensing liquids ranging in volume from a few ounces to several gallons is a diaphragm or double diaphragm pump. Movement of the internal shuttle causes substantial vibration. Over a period of prolonged use pump vibrations weaken the seals between components causing plastic hoses to loosen and be displaced, and union and couplings to fracture and leak.

Because of the severe consequences to persons and the environment of a system failure involving hazardous chemicals, a new design of equipment was undertaken. FMC Corporation has constructed a proprietary data base categorizing several decades of historical mishaps and accidents involving hydrogen peroxide. For example, fifty percent of all accidents resulted directly from poor maintenance, using the wrong equipment, or using equipment of incompatible materials of construction. Other categories of lesser frequency mishaps include operator error, forklift accidents puncturing drums or totes, and allowing incompatible chemicals to commingle. Most accidents are preventable if equipment has provision for proper conveyance of the chemical, and containment of the chemical in the event of a failure in conveyance.

In accordance with the present invention, in preferred embodiments, all components of the dispensing system are materially compatible. Materially compatible means that all components are made of the same type of material having identical coefficients of thermal expansion, stress absorption, and degree of flexibility. For hazardous chemicals the use of all stainless steel components is preferred, although some types of plastic may be suitable if all the components are molded of the same plastic composition. This includes enclosure, pump bodies, conveyance tubing, couplings, fittings, back plate, base plate, and bulk head fittings. Stainless 316 gauge is preferable to other alloys. All metal-plastic, plastic of one type wedded to another plastic type, and metal of one type wedded to metal of a different type are to be strictly avoided.

In preferred embodiments, all components are mounted rigidly, and no shock absorbent materials are utilized. It is found that attempts to cushion components of the system to absorb vibrations actually tends to localize stress and increase the incidence of failure, whereas rigidity tends to dissipate and distribute the energy of vibration by a resonance effect throughout the entire structure of the dispenser.

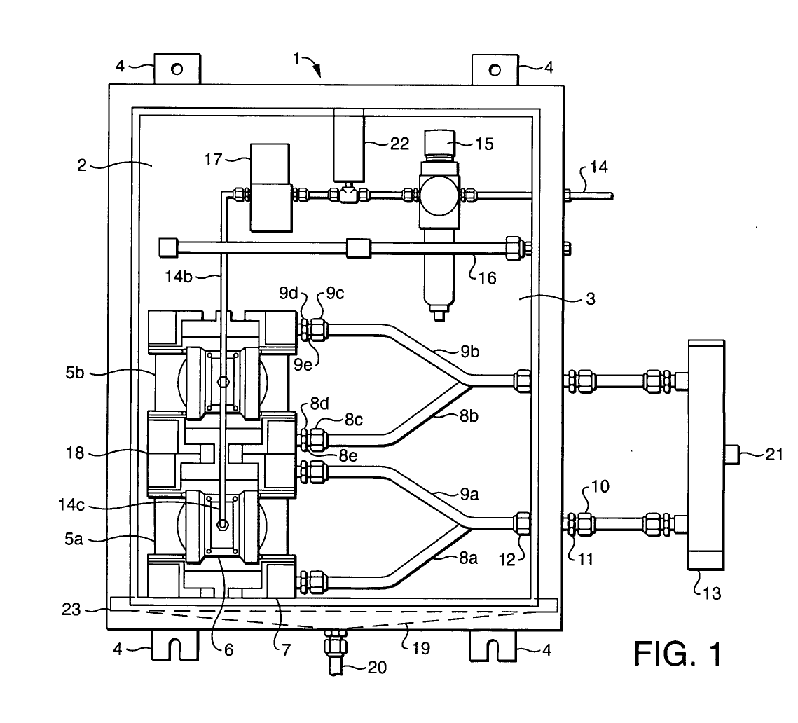

Referring to the drawings, FIG. 1 shows the pumping portion of the dispenser. An enclosure 1 is a generally rectangular stainless steel box having an opening 2 in the front side. In preferred embodiments, the enclosure should be at least NEMA 4 rated or explosion-proof. Mounting brackets 4 are provided to secure the enclosure 1 onto a flat surface such as a wall. It is intended that in normal operation, the dispenser is mounted substantially vertically.

In preferred embodiments, the enclosure contains a base plate 7 which is secured to a back plate (not shown) by a fastener. The fastener is preferably a bolt with a lock washer, but may alternatively be a weld or an adhesive. In the embodiment shown in FIG. 1, a lower double diaphragm pump 5a is secured to the base plate. An upper stackable second double diaphragm pump 5b is bolted to the top of the lower pump 5a. In other embodiments there may be only one such pump or a plurality of pumps, the number limited only by the size of available enclosures. These pumps are sized to accommodate the volumes of chemical to be displaced. There are several commercial sources of such pumps and they are available in a variety of sizes. The body of the pump is preferably stainless steel and the only non-metallic component are the chemically resistant seals, which for hazardous chemicals are typically made of Teflon. It is important that each enclosure be dedicated to one hazardous chemical only, so that commingling of two or more incompatible chemicals is strictly avoided.

In preferred embodiments, the pumps 5a and 5b are disposed between two stainless steel tubes 8a, 9a, and 8b, 9b respectively. Tubes 8a and 8b are chemical inlet conveying tubes and tubes 9a and 9b are chemical outlet tubes for pumps 5a and 5b respectively. The inlet and outlet tubes 8b and 9b, for illustration purposes, are connected to the pumps at the respective inlet orifice (bottom inlet) and outlet orifice (upper outlet) by compression type couplings comprising a body 8e and 9e, a compression inducing nut 8c and 9c for the respective inlet and outlet tubes respectively, and a stationary nut 8d and 9d to provide torque in the coupling. Such couplings are used throughout the dispenser wherein connection between elements of the conveying system is required. The preferred couplings are manufactured by Swagelok Company under U.S. Pat. Nos. 6,279,242 and 6,131,963 herein incorporated by reference, although other similar but less satisfactory couplings are available commercially. The principal advantage of the Swagelok coupler is a double ferrule feature that crimps the tubing metal so that leaks are virtually impossible, under conditions of wear from vibration, at the interface of elements such as tubing to tubing, or tubing to pump connections.

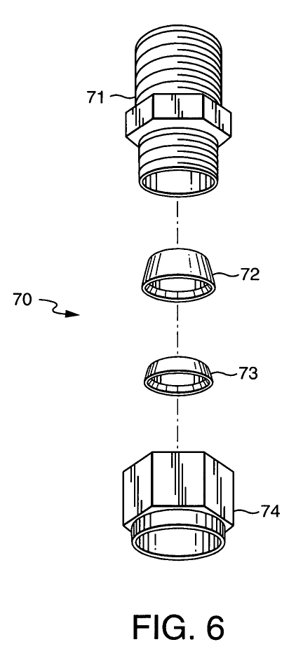

At the end opposite connection of the conveying tubes to the pump, the tubes 8a, 9a, 8b, and 9b pass through the enclosure through orifices (not shown) and are secured to the enclosure side or sides by bulk head fittings. These are preferably of the Swagelok construction and comprise a lock nut 12, a body portion 11, and a retaining or stationary nut 10. FIG. 6 further illustrates the Swagelok type double compression coupling. The coupling 70 has a threaded body portion 71, a locking nut 74, and two ferules 72 and 73 disposed between the body portion 71 and the locking nut 74. The extreme rigidity afforded by anchoring the tubes to the enclosure utilizing the bulk head fittings facilitates irradiation and transmission of the energy of vibration to the structure of the enclosure and its other components. In the view of FIG. 1, inlet and outlet tubes are parallel and so extension thereof to an inlet manifold 13 is shown as a superimposed image. The inlet manifold 13 has a chemical inlet port 21 supplying chemical to all pumps in the enclosure.

In preferred embodiments, the pumps may be air powered or electrical. Air powered pumps are preferred because most industrial plants have an ample supply of compressed air, and because air actuators are generally more reliable. FIG. 1 illustrates such an air actuated system. An air intake line 14 is connected to a pressure regulator 15 which maintains a continuously minimum 80 psi pressure. A control element 22 is a conventional sensor that monitors the status of continuous adequate air pressure, and prevents pressure from exceeding 80 psi. Actuating air flow to individual pumps is controlled by an electrically activated solenoid valve 17. In the plan view of FIG. 1, one solenoid is shown with an air tube 14b extending to the pump 5b. Actually a second identical solenoid (not shown) is situated directly behind the solenoid 17 (and is superimposed in plan view) having an air tube 14c extending to pump 5a.

In preferred embodiments, at the base of the enclosure in the lower cavity, chemical collecting means 23 having generally sloping sides 19 to a drain means 20 is sealed to the four sides of the enclosure. In the event of a leak in a pump or a coupling, chemical drains around the base plate edges, descends through the sloping collecting means 23 to the drain means 20, thereby providing safe containment of chemical. The chemical collecting means is preferably sealed to the enclosure by welding and application of an epoxy chemically inert sealant. A spray bar 16 is provided in the upper cavity to permit flushing and rinsing of the entire enclosure with a decontaminating fluid such as water or a chemical neutralizing buffer solution.

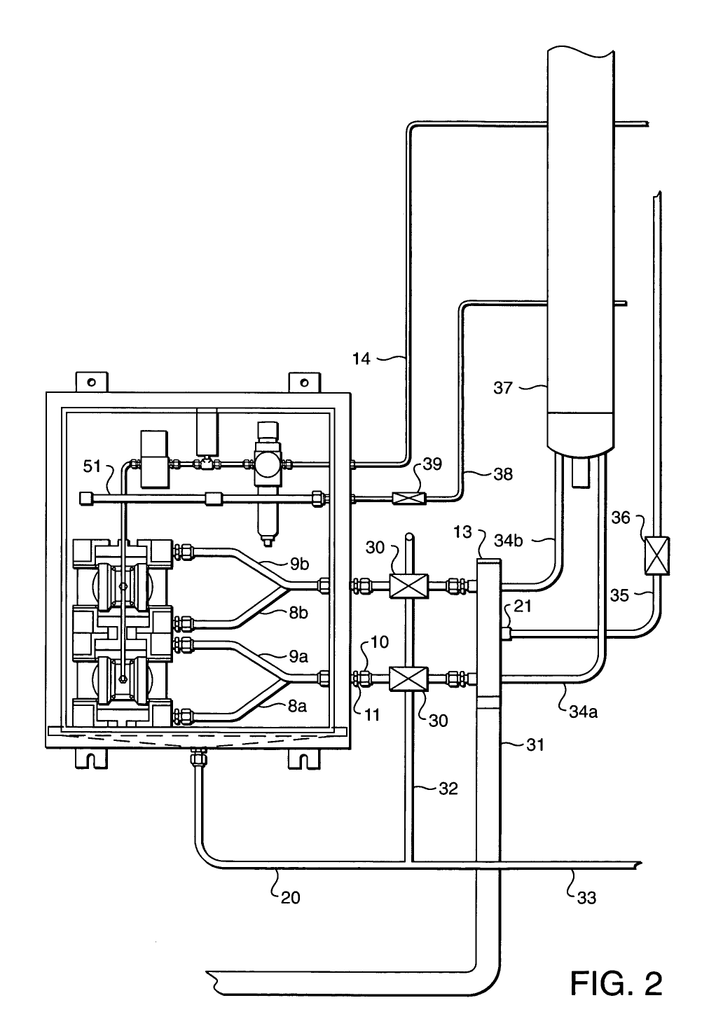

FIG. 2 illustrates a preferred pump system flushing system. In the event of a chemical spill or leak within the enclosure, or in the invent that a pump requires internal maintenance, it is desirable for operator safety, to remove all the chemical from the pumps and the inlet and outlet tubes. A decontaminating fluid inlet line 35 is connected to the chemical manifold 13 by a coupling 21. Flow of fluid into the inlet line 35 is controlled by an inline valve 36. Chemical may be drawn into the pumps on their suction side from a chemical conduit 31. A valve (not shown) disposed in line of the conduit 31 controls access of chemical to the manifold. If flushing the system is desired, this valve is turned to the off position. Two three way valves 30 (one for each pump) have an off position and two open positions. In the first open position chemical flows through outlet tubes 9a and 9b to effluent delivery tubes 34a and 34b respectively. In the second open position of valves 30, flow to delivery line 34a and 34b, and fluid flows into a drain line 32. Thus, decontaminating fluid circulates from its fluid inlet 35 through inlet tubes 8a and 8b, through the pumps, into the discharge outlet tubes 9a and 9b, to the drain 32 in a tubular loop. The chemical delivery lines 34a nd 24b are preferably encased in a PVC sheath 37 to provide further containment in the event of lead or rupture during chemical delivery.

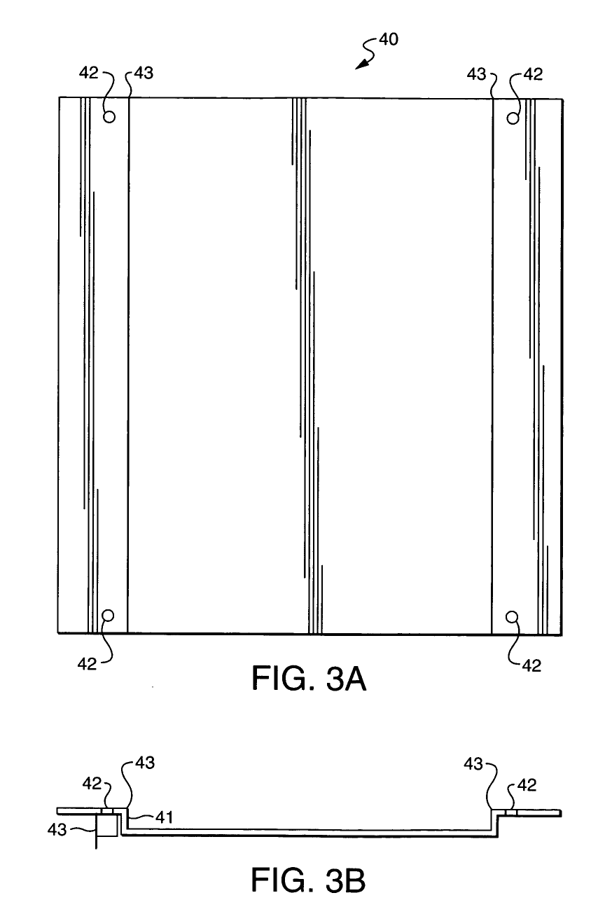

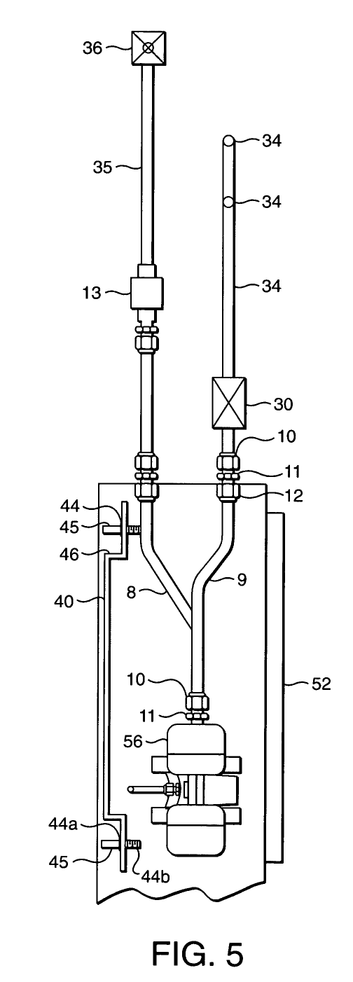

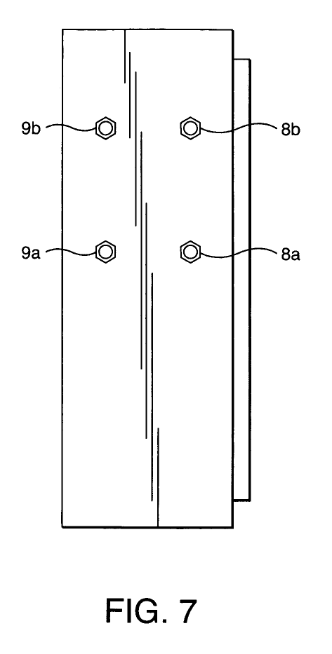

FIG. 5 is a top view of certain elements of the enclosure pumping assembly. The back plate 40 is secured to the rear wall of the enclosure by mounting on posts 45 having threaded ends 44b which are integral to the enclosure structure. In this embodiment a washer 44a is affixed, preferably by welding to the posts 45. The back plate has bores spaced alignment with the position of the posts and of sufficient diameter to allow insertion of the threaded ends of the posts through the bores, as shown in FIG. 3. Securing the back plate is completed by treading a nut (not shown) onto the threaded portion of the posts. In one embodiment, the back plate is configured to have a vertical indentation 46 formed by two 90 degree bends in the material. This feature provides strength and additional space in the enclosure for mounting the air regulators 15 and 22, and the solenoid valves 17. FIG. 5 also further illustrates the angularity of the inlet tube 8b and outlet tube 9b. The S-shape allows two dimensional positional adjustment upon rotation so that vertical axial alignment of inlet tubes and outlet tubes of all the pumps is combined with axial horizontal alignment of the inlet tube and outlet tube for each individual pump, as shown in FIG. 7.

1. An apparatus for safe dispensing of hazardous chemicals comprising:
a) an enclosure having sides and closed top and bottom surfaces and a back plate mounted therein;
b) a base plate having a vertical mounting lip placed within the enclosure and secured to the back plate to form upper and lower cavities in the enclosure, the base plate providing liquid communication means between the upper and lower cavities; and
c) one or a plurality of pumps materially compatible to the enclosure mounted on the base plate and disposed between a materially compatible chemical inlet tube and chemical outlet tube passing through the sides of the enclosure to each pump and secured to the sides by bulk head fittings, said tubes having an angularity to permit axial alignment of input and output tubes to each pump and connected to the pumps and bulkhead fittings by materially compatible compression type couplings.

2. The apparatus of claim 1, further comprising a chemical collection member sealable to the vertical sides of the enclosure to prevent liquid reflux to the upper cavity of the enclosure, and connected to one or a plurality of drains at the bottom surface of the enclosure.

3. The apparatus of claim 1, further comprising a rinse system for rinsing the dispensing system with decontaminating fluid comprising a tubular loop connecting a source of decontaminating fluid to the chemical inlet tube; a valve controlling ingress of decontaminating fluid; and a valve diverting decontaminating fluid to a drain.

4. The apparatus of claim 2, further comprising a rinse system for rinsing the dispensing system with decontaminating fluid comprising a tubular loop connecting a source of decontaminating fluid to the chemical inlet tube; a valve controlling ingress of decontaminating fluid; and a valve diverting decontaminating fluid to a drain.

5. The apparatus of claims 1, comprising a spray bar positioned in the upper cavity of the enclosure.

6. The apparatus of claims 2, comprising a spray bar positioned in the upper cavity of the enclosure.

7. The apparatus of claims 3, comprising a spray bar positioned in the upper cavity of the enclosure.

8. The apparatus of claims 4, comprising a spray bar positioned in the upper cavity of the enclosure.

9. The apparatus of claim 1, wherein said pumps are stackable.

10. The apparatus of claim 2, wherein said pumps are stackable.

11. The apparatus of claim 3, wherein said pumps are stackable.

12. The apparatus of claim 4, wherein said pumps are stackable.

13. The apparatus of claim 5, wherein said pumps are stackable.

14. The apparatus of claim 6, wherein said pumps are stackable.

15. The apparatus of claim 7, wherein said pumps are stackable.

16. The apparatus of claim 8, wherein said pumps are stackable.

17. A method for dispensing hazardous chemicals comprising conveying hazardous chemicals through a materially compatible system, said system having a flow generative of characteristic vibration, which system effectively disperses vibration energy.
